(19) United States
(12) Patent Application Publication
(10) Pub. No.: US 2012/0251970 A1
(43) Pub. Date: Oct. 4, 2012

(54) REMOVABLE BITE PLANE APPLIANCE

(76) Inventor: Douglas Awde, London (CA)

(21) Appl. No.: 13/499,484

(22) PCT Filed: Aug. 13, 2010
(86) PCT No.: PCT/CA10/01250

§ 371 Date: Jun. 18, 2012

(30) Foreign Application Priority Data
Aug. 14, 2009 (CA) 2,674,656

(51) Int. Cl. A61C 7/36; A61C 7/08

(52) U.S. Cl. 433/6

(57) ABSTRACT

A convertible oral bite plate appliance has at least one removable occusal shim attached and conforming to the outer surface of a base. The removable occlusal shim is preferably attached by complementary ribs and grooves on the lingual and buccal/labial portions of the occlusal shim and the base. Elastic bands may optionally be used to connect the maxillary and mandibular occlusal shims to pull the lower jaw anteriorly.

### FIELD OF THE INVENTION

This invention relates to removable oral appliances. More specifically, this invention relates to removable bite plane and snoring appliances.

### BACKGROUND OF THE INVENTION

A conventional bite plane appliance generally conforms to and fits over a patient's teeth, and has one acrylic occlusal plane that covers the occlusal surface of the teeth so that the maxillary and mandibular teeth cannot be brought together into contact. Posterior bite plane appliances are typically used to retain or dispose the patient's mandible in a desired position to prevent indications such as grinding and clenching of the teeth.

To prevent and treat such problems, proper occlusion is critical. According to the prior art, maximum effectiveness is achieved by using bite planes having custom-thicknesses as determined by trial and error. This requires that the patient attend at the dental professional's office for an initial fitting, and thereafter attend again for customization of the bite planes. This can often be an iterative procedure, requiring that the patient take the appliance away after modification of the bite plane to determine if it is comfortable, resolves the pathology for which the appliance was installed, and does not create other problems; and if not, reattend at the professional's office for further customization of the bite planes.

Such personalized fitting of conventional bite plane appliances tends to be difficult, typically requiring the addition of layers of acrylic to increase the thickness of the bite planes in small increments each followed by an interval of observation to determine if further modification is necessary. Thus, properly fitting a bite plane appliance can be expensive and time consuming for the patient, often requiring attendance at the dental practitioner's office multiple times for adjustments.

Occlusal shims that are removable from the bite plane base are therefore desirable. Convertible bite planes can be modified without requiring the patient's attendance at the dental practitioner's office, which assists in the initial customization of the appliance. Occlusal shims may also be interchanged with occlusal shims of differing thicknesses, which may be designed to address different problems (for example temporomandibular (TM) joint dysfunction during the day and snoring at night) or during specified periods of time upon the dental practitioner's advice. A differently shaped occlusal shim may also be desirable as the patient's treatment progresses.

Replacement of occlusal shims without replacing the bite plane and without requiring attendance of the patient at the dental practitioner's office is a significant advantage. Customized occlusal shims may be shipped to the patient after modification.

Bite planes typically used today cannot be converted to snoring appliances. A convertible bite plane that comprises occlusal shims would allow a person who parafunctions to have a bite plane that may be transformed into a snoring appliance by using appropriately shaped occlusal shims and elastics. Furthermore, the maxillary bite plane could function alone as an athletic mouthguard.

Removable occlusal shims must affix to the bite plane base in a precise immovable position in order to effectively address the patient's pathology. Further, removable occlusal shims must be secured to the base sufficiently to avoid inadvertent dislodgement, which at best can defeat the treatment and at worst can be dangerous to the patient, but are advantageously removable by the patient without the use of special tools.

### BRIEF DESCRIPTION OF THE DRAWINGS

In drawings which illustrate by way of example only a preferred embodiment of the invention,

FIG. 1 is a side view of a bite plane appliance according to the invention mounted to a patient's teeth.

FIG. 2 is a side view of maxillary and mandibular bases in the bite plane appliance of FIG. 1.

FIG. 3 is a cross-sectional view of the bite plane appliance of FIG. 1.

FIG. 4 is an exploded perspective view of the bite plane appliance of FIG. 1.

FIG. 5 is a left side view of a posterior bite plane appliance of FIG. 1 where the patient's jaw is open.

FIG. 6 is a left side view of a posterior bite plane appliance of FIG. 1 where the patient's jaw is closed in its natural position.

FIG. 7 is a left side view of a posterior bite plane appliance of FIG. 1 forcing an anteriorly disposed position of the mandible when the mouth is closed.

### DETAILED DESCRIPTION OF THE INVENTION

The invention provides a removable oral bite plane appliance comprising: a base for mounting over a patient's teeth, the base comprising an outer surface comprising an occlusal portion and sides comprising a lingual portion and a buccal/labial portion; at least one removable occlusal shim comprising an inner surface that substantially conforms to at least a portion of the outer surface of the base, comprising an occlusal portion and sides comprising a lingual portion and a buccal/labial portion; at least one projection projecting from at least one side of either the base or the occlusal shim and at least one depression complementary to the projection formed in the other of the base or the occlusal shim; whereby when the occlusal shim is fitted over the base the projection lodges in the depression to secure the occlusal shim to the base.

The invention further provides a bite plane appliance for disposing a patient's lower jaw anteriorly, the bite plane appliance comprising: a maxillary base substantially conforming to at least a patient's maxillary dentition, the maxillary base comprising an inner surface that engages at least the patient's maxillary dentition, an outer surface, a lingual portion, at least one occlusal portion and at least one buccal portion; a mandibular base substantially conforming to at least the patient's mandibular dentition, the mandibular base comprising an inner surface that engages at least the patient's mandibular dentition, an outer surface, a lingual portion, at least one occlusal portion and at least one buccal portion; and removable left and right maxillary and mandibular occlusal shims, each occlusal shim being attachable to one of the maxillary base or the mandibular base, comprising an inner surface, an outer surface, a lingual portion, an occlusal portion and a buccal portion, the inner surface of the each occlusal shim substantially conforming with a posterior portion of the outer surface of the base, each of the left and right mandibular occlusal shims having a raised occlusal portion, and each of the left and right maxillary occlusal shims have a recessed portion for abutting the raised occlusal portion of each of the opposed left and right mandibular occlusal shims, respectively.

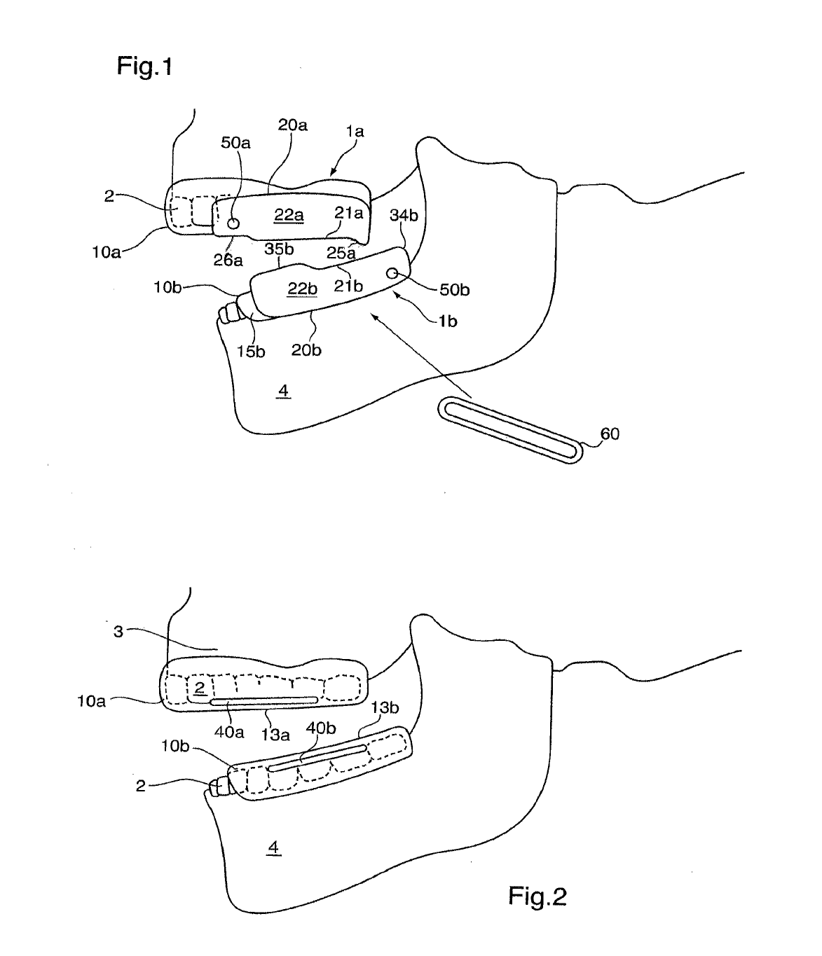

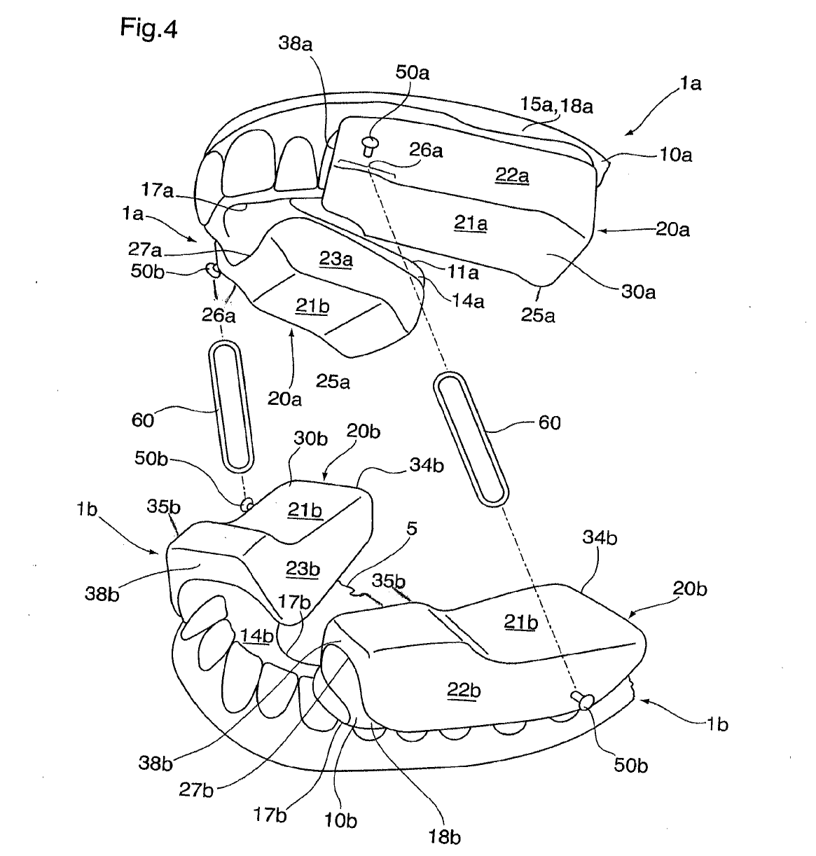

FIGS. 1 to 7 illustrate an oral appliance 1 in accordance with one preferred embodiment of the invention. FIG. 4 illustrates a patient wearing two occlusal shims according to the invention, a first occlusal shim 1 on the left side of the mouth and a second occlusal shim 1 on the right side of the mouth being generally a mirror image of the first occlusal shim 1, which is typical.

The oral appliance 1 comprises maxillary and mandibular portions 1a, 1b each having a respective bite plane base 10a, 10b, respectively associated with at least one removable occlusal shim 20a, 20b. The base 10a, 10b may be formed from a rigid plastic such as Eclipse™ acrylic or Proform™ which is suitable for the environment inside the mouth, molded on casts in a laboratory to generally conform to the patient's maxillary or mandibular dentition 2 and soft tissues 5 such that it is securely and removably held in place when mounted. The inner surfaces 11a, 11b of each base 10a, 10b engages the patient's dentition 2 and soft tissues 5 when worn.

Each base 10a, 10b has a respective lingual portion 14a, 14b, the respective outer surface 17a, 17b of which faces the tongue and palate when worn; a respective occlusal portion 13a, 13b that runs along the biting surface of the teeth 2; and a respective buccal/labial portion 15a, 15b, the outer surface 18a, 18b of which faces the cheeks/lips when worn.

The removable occlusal shims 20a, 20b each have a respective lingual portion 23a, 23b, the outer surface of which faces the tongue when worn, an occlusal portion 21a, 21b that runs along the occlusal portion 13a, 13b of its respective base 10a, 10b, and a buccal/labial portion 22a, 22b, the outer surface of which faces the cheeks/lips when worn. The removable occlusal shims may be formed from a relatively strong, rigid plastic suitable for the environment inside the mouth such as Eclipse™ acrylic or Proform™, which requires a substantial force to flex.

The outer surfaces 30a, 30b of the removable occlusal shims 20a, 20b are shaped to treat or prevent the pathology to be addressed. The inner surfaces 27a, 27b of the removable occlusal shims 20a, 20b substantially conform to the outer surfaces of the respective associated base 10a, 10b and are removably attached thereto.

In a preferred embodiment, the removable occlusal shim 20a or 20b is securely and removably attached to the base 10a, 10b by fastening elements comprising at least one projection, for example a rib 46b disposed along and protruding from the inner surface 27a, 27b of the lingual portion 23a, 23b of the removable occlusal shim 20a or 20b which interlocks with at least one complementary depression, for example a groove 40a, 40b disposed along the outer surface 17a, 17b of the lingual portion 14a, 14b of each base 10a, 10b.

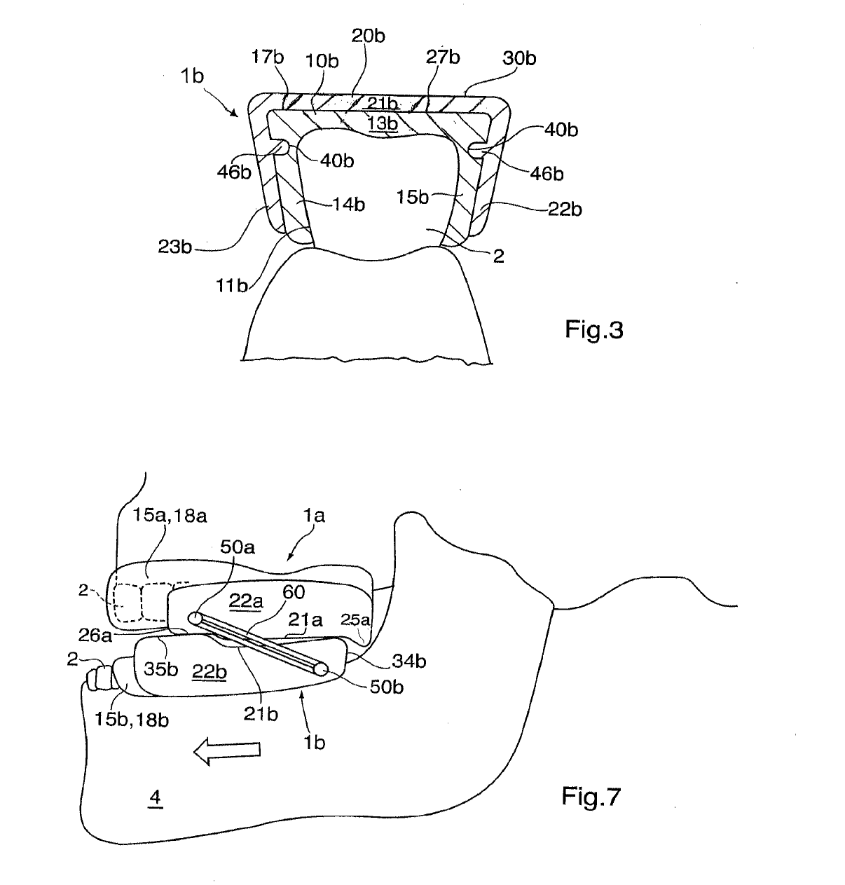

Positioning the fastening means on the sides, as opposed to the occlusal portions of the bases 10a, 10b, reduces the likelihood that the occlusal shims 20a, 20b will become dislodged accidentally or unintentionally. This is further ensured by disposing the ribs 46b and grooves 40a, 40b along the appliance 1 transverse to the direction of removal of the occlusal shims 20a, 20b, and in the preferred embodiment by providing a rib 46b and complementary groove 40a, 40b on both the lingual and buccal/labial surfaces of the appliance 1, as best seen in FIG. 3.

The ribs 46b and complementary grooves 40a, 40b are preferably (but not necessarily) integrally formed with the removable occlusal shims 20a, 20b and bases 10a, 10b, respectively. Also, preferably the rib 46b is provided along the occlusal shim 20a or 20b, the sides of which are typically thinner than the base 10a, 10b and therefore the base 10a or 10b has more room for a groove within the thickness of its sides. However, the rib 46b may be applied to either the occlusal shims 20a, 20b or the bases 10a, 10b, and the groove 40a, 40b is applied to the other of the two components.

One skilled in the art will also appreciate that the removable oral appliance disclosed herein may be an anterior bite plane appliance or a posterior bite plane appliance, the main difference being that the anterior bite planes will have a much smaller biting or occlusal area than posterior bite planes.

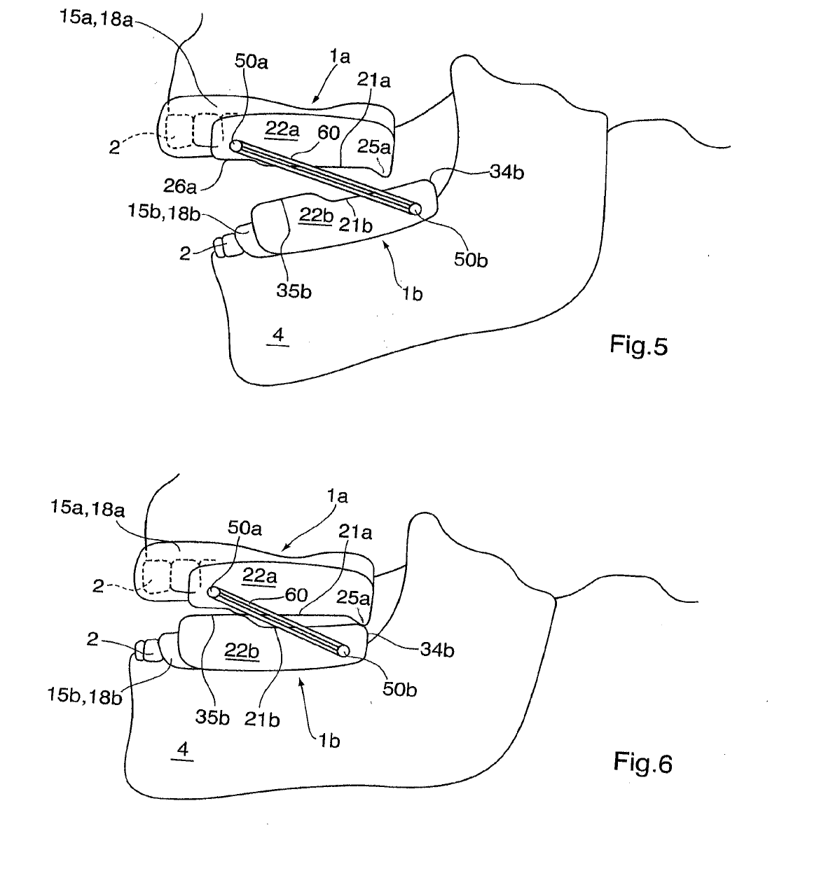

As shown in FIGS. 5 to 7, oral appliances 1 according to the invention may be used advantageously in a posterior bite plane appliance to dispose the patient's jaw anteriorly to prevent snoring. In this embodiment, each occlusal shim is optionally provided with pins or pegs 50a, 50b to which tensioning members such as elastic bands 60 may be attached to pull the patient's jaw closed and the lower jaw 4 anteriorly. The mandibular pins 50b are advantageously located toward the posterior ends 34b of the mandibular occlusal shims 20b and the maxillary pins 50a are advantageously located toward the anterior ends 38a of the maxillary occlusal shims 20a, 20b such that the tension in the elastic bands 60 draws the lower jaw 4 in an anterior direction. At least one optional elastic band 60 connects the left maxillary removable occlusal shim 20a to the left mandibular removable occlusal shim 20b. Likewise, at least one elastic band 60 connects the right maxillary removable occlusal shim 20a to the right mandibular removable occlusal shim 20b. In this embodiment of the removable left and right maxillary and mandibular occlusal shims 20a, 20b preferably also have outer occlusal surfaces 21a, 21b shaped to dispose the lower jaw 4 anteriorly. Preferably, the mandibular occlusal shim 20b has a raised anterior occlusal portion 35b and the maxillary occlusal shim 20a has a recessed anterior occlusal portion 26a for abutting the corresponding raised anterior occlusal portion 35b. When the removable occlusal shims 20a, 20b are brought together by biting, they will not be properly seated (as shown in FIG. 6) unless the recessed anterior portion 26a of the maxillary occlusal shims 20a abut the raised anterior occlusal portion 35b (as shown in FIG. 7) thereby disposing the lower jaw 4 anteriorly. In this embodiment the maxillary occlusal shim 20a may further comprise a chamfered protrusion 25a which serves as a cam, abutting the posterior end 34b of each of the mandibular occlusal shims 20b as the jaw is closed to force the mandible anteriorly and to further assist in guiding the lower jaw 4 to the desired anterior disposition.

A removable bite plane appliance 1 according to this embodiment thereby allows adjustments with three degrees of freedom: along the vertical axis by interchanging occlusal shims 20a, 20b of differing thicknesses; along the anterior-posterior axis by the shape of the outer occlusal surface of the occlusal shims and tension provided by the tensioning members 60; and, laterally by the elasticity and flexibility of the elastic bands 60. The lateral flexibility in particular allows patients who grind their teeth when sleeping to continue motion in that direction, thereby preventing or alleviating soreness in the jaw that is known to result when their lateral jaw motion is restricted.

The base 10a, 10b may be molded in any suitable fashion, and preferably the groove 40a, 40b (or if desired and if the thickness of the occlusal shim 20a, 20b permits, a rib 46b) is molded integrally with the base 10a, 10b. The occlusal shim 20a, 20b may similarly be molded in any suitable fashion, and preferably the rib 46b (or if desired and if the thickness of the occlusal shim 20a, 20b permits, a groove 40a, 40b) is molded integrally with the occlusal shim. Techniques suitable for molding these components are well known. Preferably, a dental impression is taken and sent to a laboratory where the oral appliance is made using techniques such as lost wax casting or thermoforming, both of which are well known to those skilled in the art.

An occlusal shim 20a, 20b may be fitted over the base 10a, 10b by inserting the base 10a, 10b into the occlusal shim 20a, 20b. The sides of the occlusal shim 20a, 20b will flex and spread as the ribs 46b contact the sides of the base 10a, 10b, until the occlusal shim 20a, 20b has fully seated over the base 10a, 10b at which point the ribs 46b snap into the grooves 40a, 40b, lodging the occlusal shim 20a, 20b in the desired position.

Thereafter, to modify the appliance 1 the occlusal shim 20a, 20b can be removed by prying one side of the occlusal shim 20a, 20b away from the base 10a, 10b to dislodge the rib 46b from the groove 40a, 40b, at which point the occlusal shim 20a, 20b can be separated from the base 10a, 10b and adjusted as desired by the dental professional.

Similarly, a removable bite plane appliance 1 designed to address parafunctional habits can easily be converted to and from a snoring appliance by interchanging the occlusal shims 20a, 20b with occlusal shims 20a, 20b and elastic bands 60 that dispose the patient's jaw anteriorly, and vice versa.

Various embodiments of the present invention having been thus described in detail by way of example, it will be apparent to those skilled in the art that variations and modifications may be made without departing from the invention.

What is claimed is:

1. A removable oral bite plane appliance comprising:
a base for mounting over a patient's teeth, the base comprising an outer surface comprising an occlusal portion and sides comprising a lingual portion and a buccal/labial portion;
at least one removable occlusal shim comprising an inner surface that substantially conforms to at least a portion of the outer surface of the base, comprising an occlusal portion and sides comprising a lingual portion and a buccal/labial portion;
at least one projection projecting from at least one side of either the base or the occlusal shim and at least one depression complementary to the projection formed in the other of the base or the occlusal shim;
whereby when the occlusal shim is fitted over the base the projection lodges in the depression to secure the occlusal shim to the base.

2. The bite plane appliance of claim 1, wherein the at least one projection comprises a rib and the at least one depression comprises a groove.

3. The bite plane appliance of claim 2, wherein the ribs and grooves are disposed substantially transverse to a direction of removal of the occlusal shims.

4. The bite plane appliance of claim 3, wherein at least one rib and groove is provided on the lingual portions of the base and the occlusal shim, and at least one rib and groove is provided on the buccal/labial portions of the base and the occlusal shim.

5. The bite plane appliance of claim 1, wherein the projections are integrally formed with the occlusal shim or the base.

6. The bite plane appliance of claim 1, comprising mandibular and maxillary occlusal shims provided with pins for the attachment of tensioning members.

7. The bite plane appliance of claim 6, wherein the pins are located toward posterior ends of the mandibular occlusal shims and toward anterior ends of the maxillary occlusal shims, such that a tensioning member attached to the pins draws the lower jaw in an anterior direction.

8. The bite plane appliance of claim 6, wherein the maxillary occlusal shims further comprise a chamfered protrusion which abut a posterior end of each mandibular occlusal shim as the jaw is closed to force the mandible anteriorly.

9. The bite plane appliance of claim 6, wherein opposed mandibular occlusal shims and maxillary occlusal shims comprise complementary raised and recessed portions.

10. The bite plane appliance of claim 1, wherein the occlusal shim or the base, or both, are made of a rigid plastic.

11. A bite plane appliance for disposing a patient's lower jaw anteriorly, the bite plane appliance comprising:
a maxillary base substantially conforming to at least a patient's maxillary dentition, the maxillary base comprising an inner surface that engages at least the patient's maxillary dentition, an outer surface, a lingual portion, at least one occlusal portion and at least one buccal portion;
a mandibular base substantially conforming to at least the patient's mandibular dentition, the mandibular base comprising an inner surface that engages at least the patient's mandibular dentition, an outer surface, a lingual portion, at least one occlusal portion and at least one buccal portion; and
removable left and right maxillary and mandibular occlusal shims, each occlusal shim being attachable to one of the maxillary base or the mandibular base, comprising an inner surface, an outer surface, a lingual portion, an occlusal portion and a buccal portion, the inner surface of the each occlusal shim substantially conforming with a posterior portion of the outer surface of the base, each of the left and right mandibular occlusal shims having a raised occlusal portion, each of the left and right maxillary occlusal shims have a recessed portion for abutting the raised occlusal portion of each of the opposed left and right mandibular occlusal shims, respectively, and the occlusal shims are provided with pins located toward the posterior ends of the madibular occlusal shims and toward anterior ends of the maxillary occlusal shims, such that a tensioning member attached to the pins draws the lower jaw in an anterior direction.

12. The bite plane appliance of claim 11, wherein at least one of the maxillary occlusal shims further comprises a chamfered protrusion for abutting a posterior end of the opposed mandibular occlusal shim.

13. The bite plane appliance of claim 11, wherein each of the left and right mandibular occlusal shims have a raised anterior occlusal portion, and each of the left and right maxillary occlusal shims have a recessed anterior portion for abutting the raised occlusal portion.

14. The bite plane appliance of claim 11, comprising at least one projection projecting from at least one side of either the base or the occlusal shim and at least one depression complementary to the projection formed in the other of the base or the occlusal shim, whereby when the occlusal shim is fitted over the base the projection lodges in the depression to secure the occlusal shim to the base.

15. The bite plane appliance of claim 14, wherein the at least one projection comprises a rib and the at least one depression comprises a groove.

16. The bite plane appliance of claim 15, wherein the ribs and grooves are disposed substantially transverse to a direction of removal of the occlusal shims.

17. The bite plane appliance of claim 16, wherein at least one rib and groove is provided on the lingual portions of the base and the occlusal shim, and at least one rib and groove is provided on the buccal/labial portions of the base and the occlusal shim.

18. The bite plane appliance of claim 14, wherein the projections are integrally formed with the occlusal shim or the base.
